(19) United States
(12) Patent Application Publication
(10) Pub. No.: US 2016/0217700 A1
(43) Pub. Date: Jul. 28, 2016

(54) SYSTEMS AND METHODS FOR REMOTE LEARNING

(71) Applicant: ENABLE TRAINING AND CONSULTING, INC., Milton (CA)

(72) Inventors: Benjamin Jeremy Zimmer, Milton (CA); Octavian Ciubotariu, Kitchener (CA)

(73) Assignee: ENABLE TRAINING AND CONSULTING, INC., Milton, ON (CA)

(21) Appl. No.: 15/023,711

(22) PCT Filed: Sep. 24, 2014
(86) PCT No.: PCT/CA2014/000707

§ 371 Date: Mar. 22, 2016

Related U.S. Application Data
(60) Provisional application No. 61/881,476, filed on Sep. 24, 2013.

(51) Int. Cl. G09B 5/08; G09B 5/10; G09B 5/02

(52) U.S. Cl. CPC G09B 5/08; G09B 5/02; G09B 5/10

(57) ABSTRACT

Embodiments described herein may provide improved systems and methods for remote learning in a laboratory environment by establishing dynamic connection streams via a server stack interface between hardware clients coupled to equipment and hardware, and mobile clients.

### FIELD

The embodiments described herein relate to systems and methods for remote learning, and in particular, to systems and methods for remote electronic learning for a laboratory environment.

### BACKGROUND

Teaching science and other subjects may involve a classroom in a laboratory environment, which may be a purpose built facility, configured with specialized equipment to conduct experiments or research. A laboratory may be a facility that provides controlled conditions in which scientific research, experiments, and measurements may be performed. The equipment may vary depending on various fields of science, technology, engineering, mathematics, and so on. Laboratories may be found in schools and universities, in industry, in government or military facilities, and mobile facilities.

Distance learning may be a mode of delivering education and instruction to students who are not physically present in a traditional setting, such as a classroom or laboratory environment. The source of information and the students may be separated by time and distance, or both.

Electronic learning generally refers to education or learning where users (e.g. learners, instructors, administrative staff) engage in education related activities using computers and/or other computing devices. For examples, learners may enroll or participate in a course or program of study offered by an educational institution through an electronic interface that is accessible over the Internet.

Distance learning may be facilitated by electronic learning. Distance learners may remotely receive assignments electronically, remotely participate in group work and projects by collaborating online, submit assignments and examinations for grading using electronic file transfer, an electronic mail box, and so on.

Electronic and distance learning is not limited to use by educational institutions, however, and may also be used in governments, industrial or in corporate environments. For example, employees at a regional branch office of a particular company may use distance learning to participate in a training course offered by their company's head office without ever physically leaving the branch office.

Electronic learning can also be an individual activity or self-directed study (e.g. studying an electronic textbook or watching a recorded or live webcast of a lecture) that, is not associated with or driven by a particular institution or organization.

Distance learning may occur without any face-to-face interaction between the users in the educational community, or limited amount. Accordingly, distance learning overcomes some of the geographic limitations associated with more traditional learning methods, and may eliminate or greatly reduce travel and relocation requirements imposed on users of educational services. Given that laboratory equipment is typically specialized and may be expensive, distance learning for a laboratory environment may eliminate or reduce the costs incurred by the remote learner.

There exists a need for improved systems and methods for remote learning for a laboratory environment, or at least a useful alternative.

### SUMMARY

In a first aspect, embodiments described herein provide a system for remote laboratory learning that may comprise; one or more mobile clients residing on client computing devices; one or more hardware clients coupled to equipment and hardware for a laboratory experiment or research to conduct a laboratory experiment; a server stack interface configuring a processor to establish a communication stream between the one or more mobile clients and the one or more hardware clients to remotely communicate commands and messages to conduct the laboratory experiment.

In accordance with some embodiments, the server stack interface may comprise a web socket stack to handle the communication stream between the one or more mobile clients and the one or more hardware clients.

In accordance with some embodiments, the server stack interface may comprise an application programming interface stack to authenticate the communication stream using a session identifier unique to the communication stream.

In accordance with some embodiments, the server stack interface may comprise an analytics module to provide data, performance and error tracking reports.

In accordance with some embodiments, the hardware clients may receive the commands so control the equipment and hardware coupled thereto to conduct the experiment and vary parameters of the experiment.

In accordance with some embodiments, the server stack interface may create customizable libraries for the one or more hardware clients to provide custom control configurations to the one or more mobile clients.

In accordance with some embodiments, the mobile client may comprise a login module is operable to interact with server stack interface to the client computing device.

In accordance with some embodiments, the mobile client may comprise a graph module is operable to provide feedback from analog/digital signals routed by the server interface from the hardware clients, and manipulate and generate graphs using data from experiments.

In accordance with some embodiments, the mobile client may comprise an experiment control module to provide step by step information about the experiment.

In accordance with some embodiments, the mobile client may comprise a note module operable to enable, create and manipulate notes on the experiment.

In accordance with some embodiments, the mobile client may comprise a live video module to display live video feedback from the hardware.

In accordance with some embodiments, the mobile client may comprise a help module is operable to provide overall help for the experiment through contents such as text, images, videos, and external links.

In accordance with some embodiments, the mobile client may comprise a collaboration module operable to enable experiment collaboration.

In accordance with some embodiments, the mobile client may comprise a report module operable to dynamically generate reports using the experiment data collected via the equipment and hardware, such as graph images, graph data, experiment summary, experiment steps, user notes.

In accordance with some embodiments, the mobile client may comprise a notification and analytics module which enables the client to a using to generate, configure and receive notifications and collect analytic information about the experiment and client usage.

In accordance with some embodiments, the system may further comprise one or more web client to enable creation of content for the experiments.

In accordance with some embodiments, the system may further comprise one or more web client to retrieve and present data to administrators to configure the system.

In accordance with some embodiments, the system may further comprise one or more web client to schedule experiments.

In accordance with some embodiments, the system may further comprise one or more web client to enable registration and maintenance.

In another aspect, embodiments described herein may provide a method for remote laboratory learning comprising: providing one or more mobile clients on a corresponding one or more client computing devices; providing one or more hardware clients coupled to equipment and hardware for a laboratory experiment; using one or more processors to configure a server stack interface; establishing, using the server stack interface, a communication stream between the one or more mobile clients and the one or more hardware clients to remotely communicate commands and messages to conduct the laboratory experiment.

In accordance with some embodiments, establishing the communication stream may comprise: receiving a request for a session identifier from a client, wherein the request comprises authentication data; authenticating the client using authentication data; after proper authentication, returning the session identifier to the requesting client; receiving a request for a connection stream from the client; sending a request to the client for a valid session identifier; receiving the session identifier form the client; validating the session identifier; and after proper validation, opening and completing the communication stream.

Embodiments described herein may also provide a historical record of a personal learning history for a user. Embodiments described herein may a persistent, online storage of user data which may be referred to as an individual's “personal learning history”. The system may store personal learning data is association with a user account, including but not limited to: lecture notes, lab reports (remote and non-remote), bookmarks, useful websites, quizzes, tests, evaluations, assignments, learning plans, planning tools, experiments results, research, projects, and so on. Further, the tool may enable the creation, management sharing and online progress tracking, of “individual education plans”. The education plans may allow users to set educational goals, strategies, timelines for reaching them, track their progress against them over time, and so on. The material and stored data may be highly searchable and indexed (to a user identifier, course identifier, subject identifier, tag, and so on), to allow for easy retrieval over time.

Other aspects and features will become apparent, to those ordinarily skilled in the art, upon review of the following description of some exemplary embodiments.

### DRAWINGS

Various embodiments will now be described, by way of example only, with reference to the following drawings, in which:

FIG. 1 is a schematic diagram of a system for remote learning according to some embodiments;

FIG. 2 is another schematic diagram of a system for remote learning according to some embodiments;

FIG. 3 is a further schematic diagram of a system for remote learning according to some embodiments;

FIG. 4 is a schematic diagram of a mobile client for remote learning according to some embodiments;

FIG. 5 is a schematic diagram of a web client for remote learning according to some embodiments;

FIG. 6 is a screen shot diagram of a note interface for remote learning according to some embodiments;

FIG. 7 is a screen shot diagram of a control interface for remote learning according to some embodiments;

FIG. 8 is a screen shot diagram of a note interface for remote learning according to some embodiments; and

FIG. 9 is a flow chart diagram of a method for remote learning according to some embodiments,

FIG. 10 is a schematic diagram illustrating a computer device, and associated communications networks, devices, software and firmware that may provide a platform for enabling one or more embodiments as described above.

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

### DETAILED DESCRIPTION OF VARIOUS EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, ultra mobile personal computer (UMPC) tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or a combination thereof, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media may include all computer-readable media, with the exception being a transitory, propagating signal. The term non-transitory is not intended to exclude computer readable media such as primary memory, volatile memory, RAM and so on, where the data stored thereon may only be temporarily stored. The computer useable instructions may also be in various forms, including compiled and non-compiled code.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. One should appreciate that the systems and methods described herein may enable a user to remotely control equipment to conduct experiments, and collaborate with others. The systems and methods described herein may facilitate remote learning for a laboratory environment using improved processing and communication techniques, and use of limited resources. The systems and methods described herein may provide improved computing devices configured particularly for learning for a laboratory environment. The systems and methods described herein may also provide a historical learning record for a user, by maintaining a persistent store of learning data associated with a user. The data may be searchable and indexed for subsequent retrieval.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

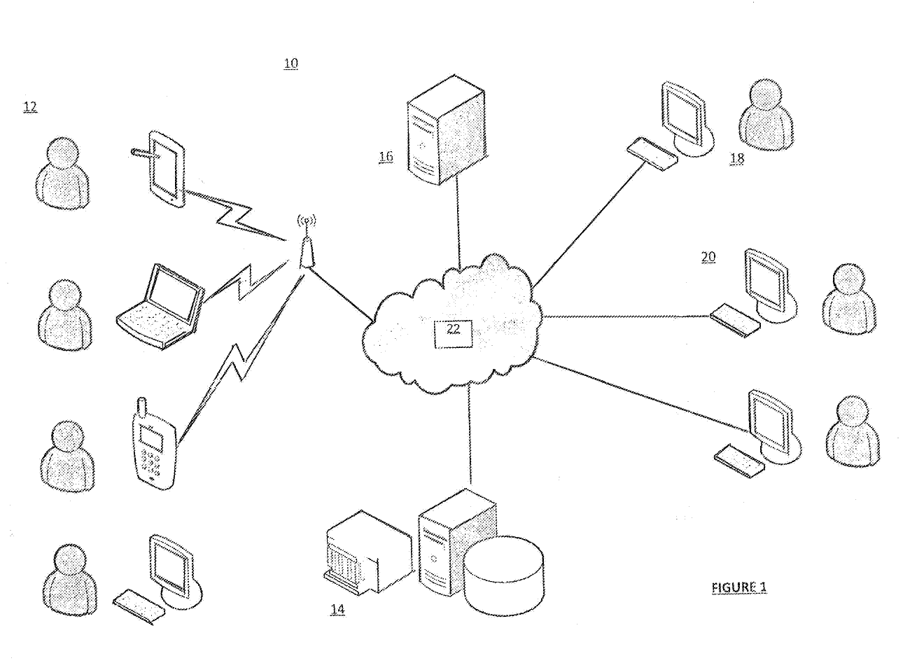

Referring to FIG. 1 is a schematic diagram of a system 10 for remote learning according to some embodiments. System 10 may be configured for enabling remote learning wherein remote learning is implemented through communication and interactions with one or more physical laboratory equipment or other hardware through one or more hardware clients.

There may be various commercial advantages associated with remote learning, such as a reduced cost/resource footprint, the ability to centralize physical equipment, the ability to provide learning in locations otherwise not conducive to or equipped for laboratory-style learning, the ability to enable collaboration between disparate individuals, the ability to conduct more sophisticated analyses than otherwise possible using traditional laboratory-learning techniques, the ability to utilize a common/shared pool of laboratory equipment that may provide more specialized apparatuses and/or a wider selection of available apparatuses, the ability to intelligently manage queues of users wishing to conduct experiments, the ability to request help from a broader range of sources, the ability to concurrently view a device along with its corresponding data, etc.

Such advantages may lead to improved learning outcomes and/or greater efficiency of resource usage. These factors may be of importance in various industries as resources are often constrained and traditional laboratory learning techniques may have limitations in regards to the learning experiences of a user. Electronic and/or computerized implementation may be helpful in achieving improved learning outcomes and/or efficiency of resource usage, and various embodiments may not be commercially achievable or possible without the specific inclusion of electronic and/or computerized implementation.

System 10 may include a remote management server 16 configured to provide remote learning for a laboratory environment. Remote management server 16 may enable improved methods of distance learning by providing client devices 12 from geographically remote locations with the ability to view, execute, and collaborate on experiments using real laboratory equipment located in remote facilities 14.

Remote management server 16 may be implemented using a server and data storage devices configured with database(s) or file system(s), or using multiple servers or groups of servers distributed over a wide geographic area and connected via a network 22. Remote management server 16 may be connected to a data storage device directly or via to a cloud based data storage device via network 22. The network 22 may include, for example, the internet, intranets, point to point networks, etc., using various networking technologies. Networking technology may include technologies such as TCP/IP, UDP, WAP, etc.

Remote management server 16 may reside on any networked computing device including a processor and memory, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these. The data storage devices may be used to provide a persistent store for a user's personal learning record. According the remote management server 16 may collect and store learning data for a user, index the data for storage, and enable subsequent search and retrieval.

Remote management server 16 may include one or more microprocessors that may be any type of processor, such as, for example, any type of general-purpose microprocessor or microcontroller, a digital signal processing (DSP) processor, an integrated circuit, a programmable read-only memory (PROM), or any combination thereof. Remote management server 16 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory “EEPROM”, or the like.

Remote management server 16 may include one or more input devices, such as a keyboard, mouse, camera, touch screen and a microphone, and may also include one or more output devices such as a display screen and a speaker. Remote management server 16 has a network interface in order to communicate with other components, to serve an application and other applications, and perform other computing applications by connecting to network 22 (or multiple networks) capable of carrying data including the internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only one remote management server 16 is shown for clarity, there may be multiple servers 16 or groups of servers 16 distributed over a wide geographic area and connected via e.g. network 22.

System 10 may include a facility 14 providing the laboratory environment. The facility 14 may include one or more laboratories specially purposed depending on a variety of science, technology, engineering, mathematics disciplines. These are illustrative examples and there may be other types of laboratories. The laboratories may include equipment and hardware to conduct experiments or research. The equipment may include or be coupled to electronic components to interface with hardware clients, as will be described herein. Generally, the hardware clients may receive remote control commands to actuate, activate or otherwise control the equipment. The hardware clients may also collect data regarding experiments from sensors and/or measurement devices of the equipment, storage in data storage devices or transmission via network 22. The equipment may also include video and audio capture devices operable to generate a video and audio data stream of experiments and other equipment. The video and audio data stream may he stored in data storage devices or transmitted via network 22, The video and audio data stream may be transmitted and viewed in near-real time, and may be stored locally or remotely for later retrieval and playback.

In some embodiments, the hardware clients may also be configured such that information is processed prior to transmission or following reception. For example, a hardware client may compress, translate and/or filter information received at a sensor prior to transmitting information to the system, or, pre-process information received and translate said information into commands specific for the control of said equipment or hardware.

Various types of signals may be captured and/or communicated by the hardware client, which may include, and is not limited to, analog signals, discrete signals, digital signals, encoded signals, etc.

The interfaces between the hardware clients and the equipment and/or hardware may be uni-directional, bi-directional, and may further be configured for communicating information in a synchronous, asynchronous and/or batch process.

The facility 14 may include a server (such as described above in relation to e.g. remote management server 16). The server may be a remote management server 16 in some embodiments. The server may be coupled to remote management server 16 in some embodiments. The server may be coupled to one or more data storage devices, such as described herein in relation to remote management server 16.

System 10 may include one or more client computing devices 12 operable by users to access the remote management server 16 to enable the users to engage in remote learning for a laboratory environment. The client device 12 may be implemented using one or more processors and one or more data storage devices configured with database(s) or file system(s), or using multiple servers or groups of servers distributed over a wide geographic area and connected via a network (which may be referred to as “cloud computing”).

Client device 12 may reside on any networked computing device, such as a personal computer, workstation, server, portable computer, mobile device, personal digital assistant, laptop, tablet, smart phone, WAP phone, an interactive television, video display terminals, gaming consoles, electronic reading device, and portable electronic devices or a combination of these.

Client device 12 may include a processor, such as, for example, a microprocessor or microcontroller, a digital signal processing (DSP) processor, an integrated circuit, a field programmable gate array (FPGA), a reconfigurable processor, a programmable read-only memory (PROM), or any combination thereof. Client device 12 may include computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Client device 12 may include one or more input devices, such as a keyboard, mouse, camera, touch screen and a microphone, and may also include one or more output devices such as a display screen and a speaker. Client device 12 has a network interface in order to communicate with other components, to serve an application and other applications, and perform other computing applications by connecting to network 22 (or multiple networks) capable of carrying data including the Internet, Ethernet plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Although only four client devices 12 are shown for simplicity and clarity, there may be more client devices 12 distributed over a wide geographic area and connected via e.g. network 22. Client device 12 is operable to register and authenticate users (using a login, unique identifier, and password for example) prior to providing access to applications and server 16. Client devices 12 may be different types of devices and may serve one user or multiple users.

System 10 may also include an administrator device 18. The administrator device 18 may be implemented using one or more processors and one or more data storage devices configured with database(s) or file system(s), or using multiple servers or groups of servers distributed over a wide geographic area and connected via a network (so called which may be referred to as cloud computing). The administrator device 18 may reside on any networked computing device, such as described herein in relation to client device 12. The administrator device 18 may be used by an administrative user to configure components of system 10. The administrator may have access and permissions to configure different components of system 10, where such administrative access and permissions are not permitted for other users. For example, administrator users may be permitted to administer and/or define global configuration profiles for the system 10, define roles within the system 10, set security profiles associated with the roles, and assign the roles to particular users in the system 10. The administrator may manage one or more components of the system 10. Although only one administrator device 18 is shown for simplicity and clarity, there may be more distributed over a wide geographic area and connected via e.g. network 22. The administrator device 18 may require security authorization and authentication via a log in and password. In order to modify and configure components. The administrator device 18 is operable to register and authenticate users (using a login, unique identifier, and password for example) prior to providing access to applications and server 16. The administrator device 18 may be different types of devices and may serve one user or multiple users.

System 10 may include one or more web interface devices 20 operable by users such as instructors, facilities employees, teaching assistance, and so on. The web interface devices 20 may be implemented using one or more processor's and one or more data storage devices configured with database(s) or file system(s), or using multiple servers or groups of servers distributed over a wide geographic area and connected via a network (so called which may be referred to as cloud computing). The web interface devices 20 may reside on any networked computing device, such as described herein in relation to client device 12. The web interface devices 20 may be used to manage content for courses, experiments, and so on, as will be described herein. The web interface device 20 is operable to register and authenticate users (using a login, unique identifier, and password for example) prior to providing access to applications, facility 14, and server 16. The web interface device 20 may be different types of devices and may serve one user or multiple users. Although only two web interface devices 20 are shown for simplicity and clarity, there may be more distributed over a wide geographic area and connected via e.g. network 22.

Client device 12, administrator device 18, and web interlace device 20 may be configured with various computing applications, as will be described herein. A computing application may correspond to hardware and software modules comprising computer executable instructions to configure physical hardware to perform various functions and discernible results. A computing application may be a computer software or hardware application designed to help the user to perform specific functions, and may include an application plug-in, a widget, instant messaging application, mobile device application, e-mail application, online telephony application, Java application, web page, or web object residing, executing, running or rendered on the respective device. The device may include a computing application in order to access the functionality of server 16, by providing and receiving data and carrying out actions and instructions, for example.

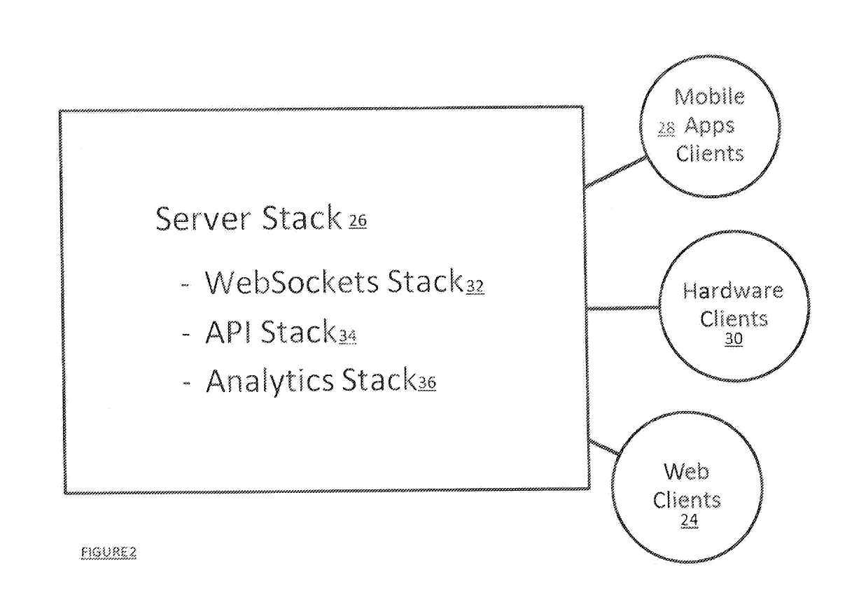

FIG. 2 is another schematic diagram of components used for remote learning according to some embodiments. Remote management server 16 may be configured with hardware and software modules comprising computer executable instructions to configure physical hardware and equipment to perform various functions and discernible results, including a server stack interface 26. The server stack interface 26 may include a WebSockets stack 32, an application programming interface (API) stack 34, and an analytics stack 36. The server stack interface 26 may be implemented as a cloud computing solution, operable to interact with other system 10 components via network 22 to provide remote learning services. The server stack interface 26 is operable to interface with mobile clients 28 (e.g. residing and running on client devices 12), hardware clients 30 (e.g. coupled to laboratory equipment or other hardware), web clients 24 (e.g. residing and running on web interface devices 20 or administrator devices 18), and other components.

Analytics stack 36 may be a combination of hardware and software modules to configure physical hardware to perform various functions. Analytics stack 36 is implemented into the server 16 stack for data management, reporting, performance, error tracking, and so on. Throughout the usage of and interaction with all components of the system 10, data will be collected and stored by analytics stack 36 as analytics for future study, processing, benchmarking, correlations, pattern detection, and so on. This analytic data may be analyzed in various ways, such as for example, in order to study user learning paths, user behaviour, user interaction with services, effectiveness of each service, perform business and market research, collect hardware support data, predict system and service enhancements, reduce system and service downtime, measure system and service traffic, security breaches, and so on. The data can be collected or stored using a variety of methods, including programmatically and/or using third party services such as Google Analytics. Analytics stack 36 may be configured to interface with other components to transmit and receive analytics data.

WebSocket stack 32 may be a combination of hardware and software modules to configure physical hardware to perform various functions. WebSocket stack 32 handles connections between the Mobile App Clients 28 and Hardware Clients 30. WebSocket communication may be secure because such that clients 28, 30 have to authenticate to the API stack 34 before any messages and commands are permitted to flow between clients 28, 30.

For example, client 28 will access a remote experiment using messages passed via WebSocket stack 32. When a client 28 application is launched by a user, they can select which experiment they would like to control from a list of available experiments. The list will show an image for the experiment, a tile, summary and the current waiting time before the user can gain control to the experiment (other users might be queued to use the experiment). As an illustrative example, an experiment may be authored to have five steps at five minutes each. The user can leave the queue in between steps and finish the experiment at a later time by reengaging WebSocket stack 32. When authored, each experiment may have a time limit, and the user may be warned before this time expires and may be kicked out of the queue when the time is completely expired. This feature may still allow the user to explore data already collected, finish taking notes and complete a report.

API stack 34 is hardware and software module to configure physical hardware to perform various functions. An API may specify how components interact with each other. API stack 34 allows access to server side scripts which can extend access to clients 28, 30 for tasks and features available through system 10. API stack 34 may include a security module which every client 28, 30 may have to authenticate through in order to gain access to components of the system 10. Access to the API stack 34 may have to be authenticated and each tasks may require a user level or role in order for the task to be performed. The user levels may be defined by administrators through Web Apps via administrator device 18, such as a User Maintenance Tool, as will be described herein. Some example tasks include: maintaining users, maintaining experiments, scheduling users and experiments, and so on. Tasks may require read/write access to a database or file system of a data storage device, which also may require a client 28, 30 to be associated with a role or level permitting read/write access.

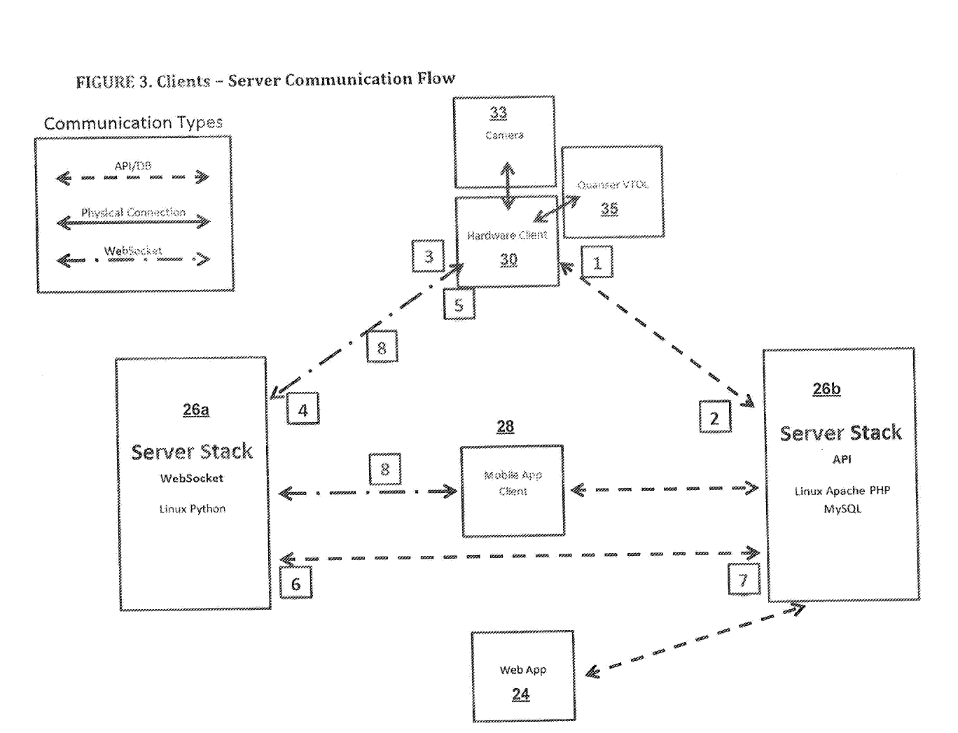

FIG. 3 is a further schematic diagram of a data flow between components of system 10 for remote learning according to some embodiments. The data flow shown is an illustrative example for establishing a connection stream between mobile clients 28 (e.g. residing and running on client devices 12), hardware clients 30 (e.g. coupled to laboratory equipment or other hardware), web clients 24 (e.g. residing and running on web interface devices 20 or administrator devices 18).

A sample handshake is shown using the numbered squares 1-8;

1. Client requests API for Session ID using username and password.

2. API returns Session ID after proper authentication.

3. Client request connection from WebSocket Server.

4. Server responds with request for a valid Session ID.

5. Client returns Session ID to WebSocket Server.

6. WebSocket Server asks API if received Session ID is valid.

7. API returns if Session ID is valid or not.

8. Socket Stream authentication is complete and open. Additional clients have to follow steps 1-7 to be part of the same stream.

The hardware client 30 in this illustrative example is connected to equipment or hardware including a video camera 33 and Vertical Take-Off and Landing (VTOL) Trainer 35 which is an aerospace plant or device that enables students to learn about basic flight dynamics and control. These are non-limiting illustrative examples.

An example describing an embodiment wherein the hardware client may be connected to a vertical take-off and landing trainer may be found further in this description.

Hardware clients 30 may include a series of libraries or software/hardware 10 applications connected directly or indirectly to laboratory equipment or hardware. Hardware clients 30 may be configured to communicate with the servers 16 which in turn route information to the Mobile clients 28. Hardware clients 30 also receive hardware control commands from the servers 16 which were routed from the Mobile clients 28. Hardware clients 30 are configured with hardware specific libraries that can interface with the Server Stack 26 to expand experiment access from the Mobile clients 28. The Server Stack API 34 may allow third parties to create customizable libraries to allow access of custom hardware to the Mobile clients 28. The customizable libraries may be generated for particular development environments, hardware, equipment, clients, and so on.

For example, hardware client 30 is shown connected to VTOL hardware 35 which may require a specific set of commands sent from a program/software written/developed in particular development environment (e.g. LabVIEW™ which is a development environment provided by National Instruments™). This program/software may reside on the hardware client 30 device. This program/software may make use of the customizable libraries written/developed in the same programming environment (in this example case LabVIEW™) which may allow hardware and equipment to be controlled by mobile clients 28. These customizable libraries may be programmed/developed to access and use the services of Server Stack API 34 and WebSockets Stack 32.

In some cases there may be other hardware which requires its control software to be developed in other development environments (e.g. .NET which is a development environment provided by Microsoft™) in which case customizable libraries will be developed in another development environment (e.g. .NET) to gain access to Server Stack API 34 and WebSockets Stack 32.

The customizable libraries may be created by third parties or provided by to Server Stack 26 in order to allow existing hardware control software to behave as a hardware client which can interface with Server Stack 26.

Hardware clients 30 can interface with equipment and hardware like Quanser™ Hardware (VTOL, QUBE™), National instruments™ Hardware, Data Acquisition Hardware, cameras, servos, drives, motors, robots, digital displays, laser systems and many more.

In this illustrative example, server stack interface 26 is shown distributed across two hardware servers configured with server stack interfaces 26a, 26b. One server stack interface 26a is shown to be configured with websocket stack 32 and the other server stack interface 26b is shown to be configured with an API stack 34.

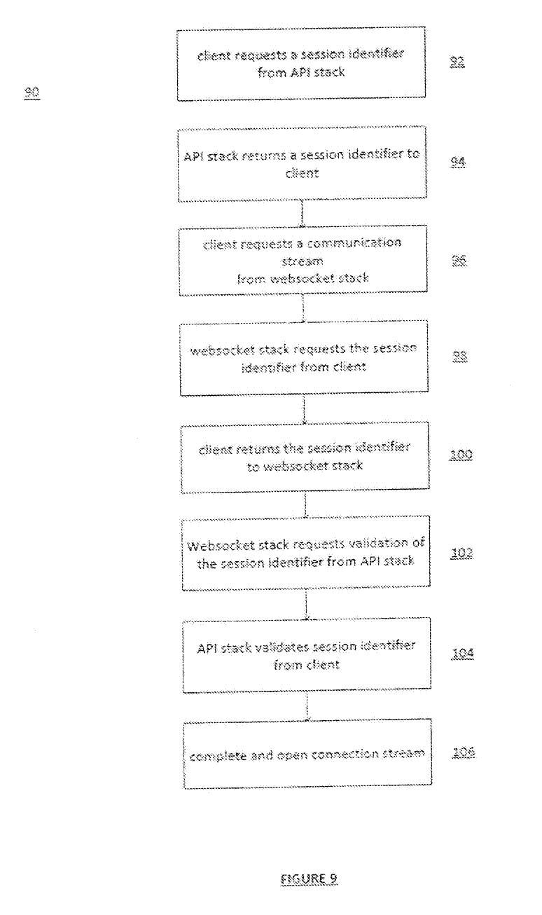

In this illustrative example, the data flow establishes a connection stream between a mobile client 28 and hardware client 30 so that the mobile client 28 can provide messages and commands to the hardware client to remote control experiment equipment. The mobile client 28 may receive data regarding the experiment from the hardware client 30. FIG. 9 is a flow chart of a method 90 for establishing a connection stream between mobile client 28 and hardware client 30 for remote interaction via commands, messages, experimental data, and so on.

The mobile client 28 and hardware client 30 requests a session identifier from API stack 34 (of server stack interface 26b) using an authentication mechanism such as an associated user name and password (92). The session identifier is linked to the communication stream. The session identifier may uniquely identify the communication stream from other open communication streams. The API authenticates the mobile client 28 or hardware client 30 using the provided user name and password and, after proper authentication, returns as session identifier to the requesting mobile client 28 or hardware client 30 (94).

For example, when a user is authenticated, a session identifier may be generated and associated with the user. The session identifier may be unique to a particular user or client. The session identifier may be a time-based identifier with an assigned valid time period. The session identifier may expire if not used within the expiration time assigned to it. A user may be authenticated using a mobile client 28, a hardware client 30 or a web client 24. Every time a client is authenticated a session identifier is generated which will be used by the client 28, 30 or 24 until session identifier is destroyed. The session identifier can be destroyed by its expiration time or by the user performing a log-out or session termination action from a client 28, 30 or 24. Session identifiers are checked for presence and validity for every incoming message to the Server Stack API 34 and WebSockets Stack 32. Any incoming messages may be discarded if the session identifier is invalid or missing. Each message may have other information attached including but not limited to: Recipient, Sender, Sender type (e.g. with regard to client 28, 30, 24), Session Identifier, Message Body, and so on.

A mobile client 28 or hardware client 30 requests a connection stream from websocket slack 32 (96). The websocket stack 32 responds with a request for a valid session identifier (98). The mobile client 28 or hardware client 30 returns the session identifier to the websocket stack 32 (100). The websocket stack 32 interacts with the API stack 34 to validate the received session identifier (102). The API stack 34 responds indicating whether the session identifier is valid or not (104). The connection stream (e.g. socket stream) authentication is complete and open (106). The mobile client 28 can send messages and commands to the hardware client through the open connection stream. Additional clients 28, 30 may join the connection stream by authenticating and obtaining a valid session identifier, and the data flow process described (e.g. additional client 28, 30 have to follow the steps (92)-(106) to be part of the same connection stream.

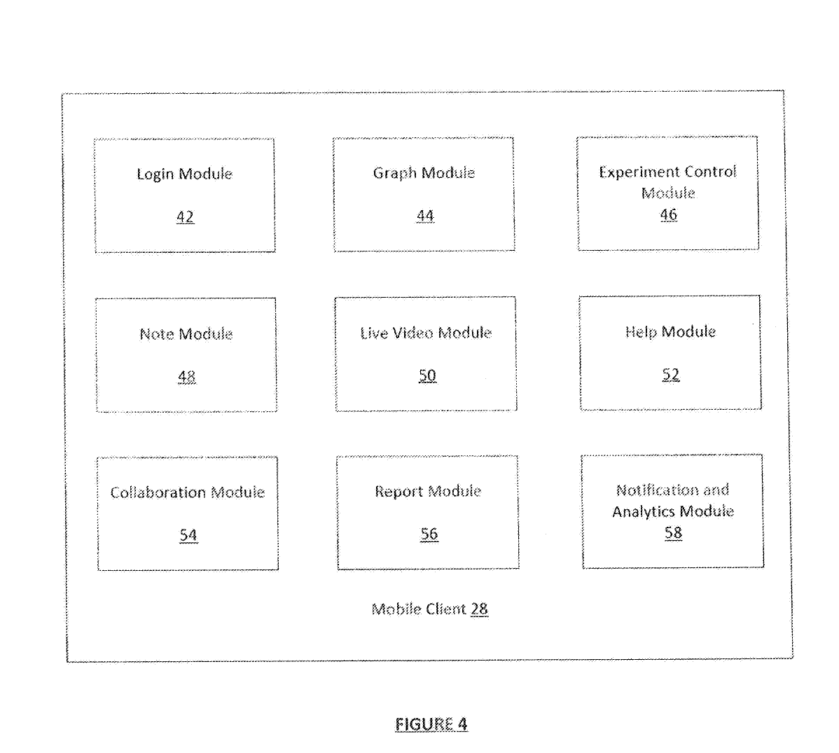

FIG. 4 is a schematic diagram of a mobile client 28 for remote learning according to some embodiments. Mobile client 28 may include a number of functional modules including login module 42, graph module 44, experiment control module 46, note module 48, live video module 50, help module 52, collaboration module 54, report module 56, and notification and analytics module 58.

Mobile Client 28 may enable users to interact and complete experiential laboratories, hardware and equipment remotely. Mobile Clients 28 may be developed and configured for various device platforms, including for example, iOS™ (e.g. IPad™), Android™, Windows/OSX™ Web Apps, Windows/OSX™ Stand Alone Apps, and so on.

Login Module 42 is operable to authenticate a user by receiving a username and password. Login Module 42 may interact with other components such as API stack 34 to authenticate user and mobile client 28. Login Module 42 may access login credentials from third party services and servers, such as Facebook™, Twitter™ and Google+™ for easier access, login, sharing of data, and so on.

Graph Module 44 is operable to provide feedback from analog/digital signals routed by the server interface 26 from the Hardware Clients 30. Graph module 44 can be used by users currently waiting in queue to view the type of data (and data reports such as graphs) that other users are experiencing while waiting for their turn n the queue. This option can be controlled by the administrator users while authoring the experiment content using the Web client 24. The user currently waiting in queue can view data from any available experiment, not only from the current experiment they are waiting for. Graph Module 44 is operable to interact with graphs shown in an interface screen of client device 12 using gestures, such as pinch to zoom, swipe left/right, drag left/right, double tap to add note, and so on. Graph Module 44 is operable to implement an Auto Scroll feature where the Graph auto scrolls as new data gets rendered. Graph Module 44 is operable to implement an Auto Scale feature where the Y scale is adjusted automatically to fit all data on screen at the current X scale.

Experiment Control Module 46 provides users with step by step information about the experiment. Experiment Control Module 46 can be used to teach users concepts about what they are about to experiment with. The Experiment Control Module 46 is operable to provide Control and Experiment Steps or Pages which will be authored by administrator users such as teachers using Web client 24. Steps/Pages may contain surveys, various types of buttons, sliders, videos, images, links, text, hints and so on. In some embodiments, the Experiment Control Module 46 may be configured to automatically identify various information about the experiment, for example, the type of equipment, the person conducting the experiment, the time of the experiment, how long a user has been on a step, what step a user may be currently conducting, etc., and may adjust information displayed accordingly. In further embodiments, the various information shown by the Experiment Control Module 46 may be personalized based on information gathered about a particular user.

Note Module 48 is operable to enable the user to make notes on the experiment such as data shown on an interface screen. A double tap on the graph may allow the user to add a note a the x, y coordinates position that was tapped, for example. These notes can be used to create a report (e.g. using report module 56) which can be shared through all the popular social media channels or submitted for evaluation. The notes window keeps track of all notes made by all users throughout the experiment. Tapping a note may transpose the points on the graph allowing the user to review where it was placed. Swiping left/right on the note may allow the user to delete a note. Other gestures may also be used to manipulate notes.

Live Video Module 50 may provide the user with the ability to view live video feedback of the hardware they are currently using/controlling. This may improve the overall fun factor which affects the learning experience. The video may also be a pre-recorded video of experiments that were previously conducted. The video may be captured using a video camera proximate to the equipment and hardware of the experiment. The video can be used by users currently waiting in queue to view what other users are doing while waiting for their turn in the queue. This option can be controlled by the administrator users while authoring the experiment content using the Web client 24. The user currently waiting in queue can view the live video from any available experiment, not only from the current experiment they are waiting for. The Live Video Module 50 may be synced with Graph Data from Graph Module 44. Live Video Module 50 is operable to provide the ability to Stop/Start the live video on demand. The video feedback may be generated by a video camera or other suitable apparatus that may be associated with the hardware being controlled, or directly attached and/or on the hardware. For example, there may be an external camera that is focused on the area in which hardware moves. Hardware clients configured for operation with such hardware may also be configured for interfacing with the external camera associated with said hardware.

Help Module 52 is operable to provide overall help for the application, which may be triggered using the in-app Help button. The help window can also be triggered and shown by the Help or hint buttons from the control panel. When this is done, the help window may automatically load linked content to the specific help/hint button that was pressed. This allows administrator users to add hints or help for every button, video or label that they author using the Web client 24. The help window can have contents like text, images, videos, external links and so on. Videos can be played in the help window or can be maximized. The help module 52 includes easy navigation through various methods including filters, searching, sorting and more.

The Help Module 52 is also used to present the Mobile Client 28 Interface Help. Each type of Mobile Client 28 will have help sections written specifically for that client type. The help sections can be authored by administrators using the Web Client 24.

Collaboration Module 54 is operable to enable users to share reports, data and experiment experience through other Mobile Client 28 clients and social media channels. Users can share invitations (such as via link to an online resource) for experiment collaboration. User can invite other users to collaborate on the same experiment using additional Mobile Client 28. Original user can allow other users to provide feedback through live chat, notes and other interactions using a secondary Mobile Client 28. Lab Administrators may allow or force users to complete a certain step or experiment in collaboration mode or completely disable the collaboration mode for certain experiments. The Administrator may grant some users read/write permissions and others read-only permissions. This enforces all users to participate in the overall experiment. The collaboration with social media channels may be through one or more electronic or computer interfaces. These interfaces may expose various functionality associated with the social media channels, such as being able to post on a posting wall, share with contacts, broadcast a message, etc.

Report Module 56 is operable to generate reports using the experiment data collected via equipment and hardware in laboratories. Once finished with the experiment, the user can create a report which can be saved in the cloud (e.g. data storage device coupled to network 22), sent to an e-mail address or shared with peers through social media channels. The report may be dynamically created based on all available information such as graph images, graph data, experiment summary, experiment steps, user notes, and so on.

Notification and Analytics Module 58 is operable to generate, configure and receive notifications and analytic information about an experiment, usage of Mobile Client 28, errors and more. Analytics are implemented into all clients and server stacks (Mobile Apps Clients 28, Hardware Clients 30, Web Clients 24 and Server Stack 26). The analytics may provide details with regards to data usage, feature usage, curriculum usage, client usage, technology used, survey data, and so on. The notification system is used to send notifications to the client device 12 with warnings and alerts. This allows the user to perform background tasks on their devices without having to leave the client 28 open. The user will be notified of alerts or tasks that require their attention.

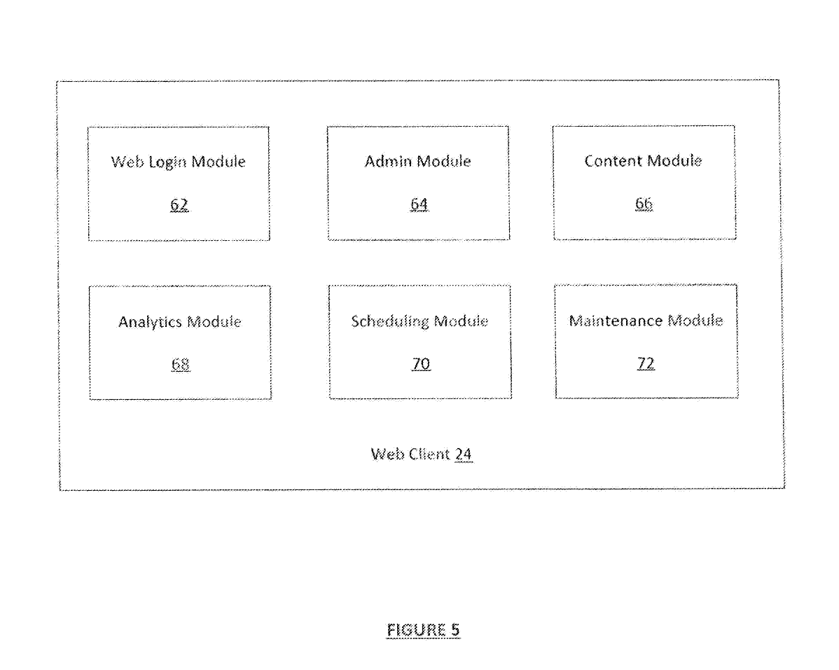

FIG. 5 is a schematic diagram of a web client 24 for remote learning according to some embodiments.

The web client 24 is operable to provide a series of online software/hardware applications which can be used by web interface devices 20 and administrator devices 18, and may also be used to access the Server Stack 26.

Web login module 62 is operable to authenticate a user using an authentication mechanism such as a username and password.

Administrator module 64 may enable an administrator to configure the system 10 globally, as described herein. The administrator module 64 may be triggered based on particular login authentication as a particular user may be assigned an administrator role.

Content tools 66 (e.g. Experiential lab authoring tools, Quiz Authoring tools) may be configured to enable creation of content for the experiments and research, as well as other content that may be used by mobile clients 28 and hardware clients 30. For example, the content tools 66 may be used to author experiments and directed research for mobile clients 28 and hardware clients 30. This content may be stored in the data storage device (e.g. server 16, facility 14). The content may be created and stored through the API Stack 34, for example, and may be pulled down by the hardware and mobile clients 28, 30 through the Server Stack interface 26. The content module 66 may also be used to author quiz, test, assignment, and assessment modules which will be served through Mobile clients 28.

Analytic module 64 may be used to retrieve and present data to administrators from data storage devices (e.g. server 16, facility 14). This data may include mobile client 28 data, Server Stack 26 data and hardware client 30 data, and so on. The data may relate to experiments, usage, and so on.

Scheduling Tools 70 can be used by administrators to schedule experiments, assessments, research assignments, and so on. Experiment start and end times (can be done per user basis) can be controlled using Scheduling Tools 70. For example, an experiment may be associated with a valid start date/time and end date/time. A user may only be able to conduct the experiment during the valid period of time. Experiment access can be limited to specific Users/Groups using Scheduling Tools 70. Experiment sessions duration times (can be done per user basis) can be controlled using Scheduling Tools 70. Other timing aspects of experiments, assessments, and research assignments can be controlled via Scheduling Tools 70, such as for example the length of time a user can spend completing the experiment. Various logic may be utilized in determining scheduling in respect of experiments, such as incorporating workflows, incorporating logical rules, scheduling specific actions/controls, scheduling notifications, queuing actions, etc.

Maintenance tools 72 can be used to enable registration process. For example, maintenance tools 72 can be used to enable/disable login through third party services, such as Facebook, Twitter, Google+. Maintenance tools 72 can be used to create users and groups of users, which may be associated with one or more experiments, permissions, and so on. Maintenance tools 72 can be used to edit user profiles, information, change/reset passwords, delete accounts, and so on.

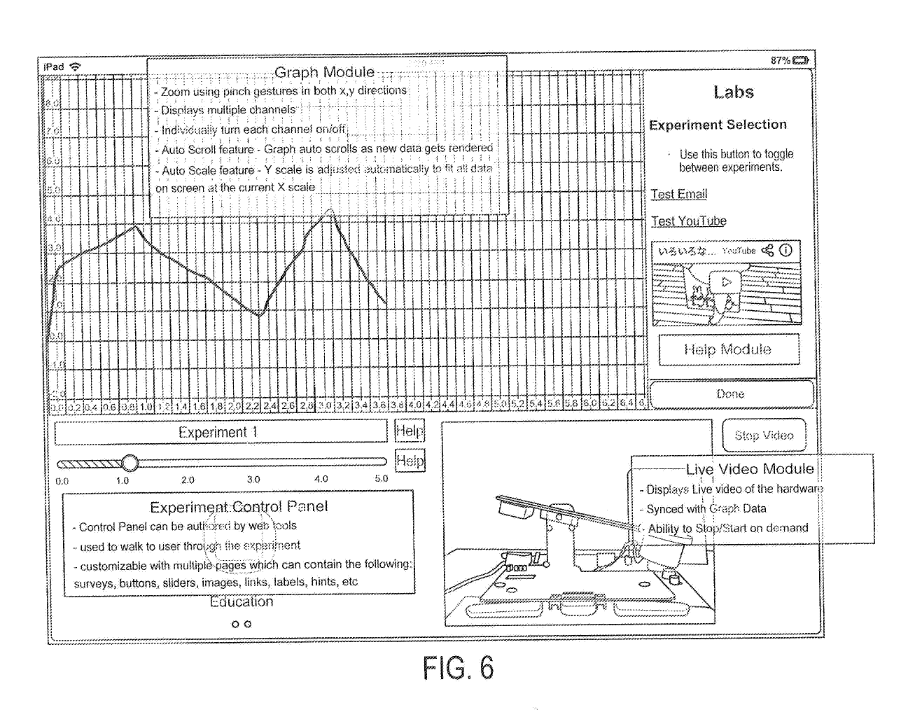

FIG. 6 is a screen shot diagram of an experiment interface for remote learning according to some embodiments. The experiment interface may render on mobile client 28 and client device 12.

The experiment interface may show a graph (generated by graph module 44) which may be manipulated using gestures via graph module 44, as described herein.

The experiment interface may include an experiment selection module to select and toggle between different experiments, research assignments, and so on available to a user.

The experiment interface may include an access tool (e.g. links, buttons, triggers) to provide access to help features via help module 52. The access tool when activated may trigger and launch help module 52.

The experiment interface may include a video display portion to display live or pre-recorded video of the experiment from live video module 50.

The experiment interface may include an experiment control module 46 to guide the user through steps of an experiment. The experiment control module 46 is customizable via web client 24 to illustrate steps and aspects of the experiment via surveys, buttons, sliders, progress bards, images, links, hints, and so on.

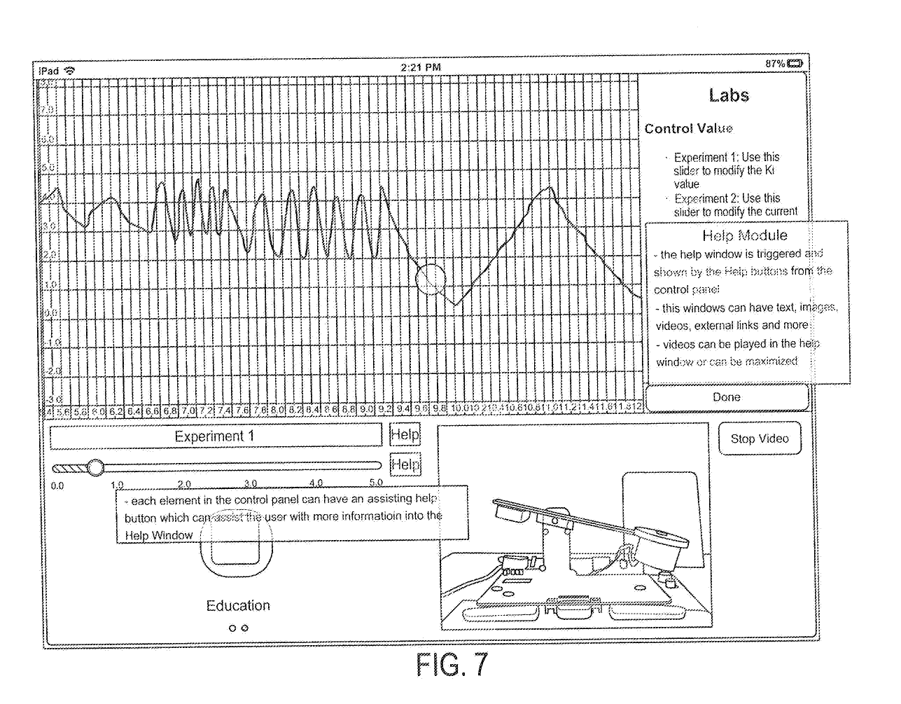

FIG. 7 is a screen shot diagram of a control interface for remote learning according to some embodiments.

The control interface may be used to control hardware and equipment (via hardware client 30) of the experiment. Different interface buttons may be used to actuate hardware and equipment (via hardware client 30) for different experiments. A live video may show a video of the experiment and the graph may be dynamically updated to show changing parameters controlled via control interface. Each element in the control panel may have an assisting help button to assist the user with more information for conducting the experiment.

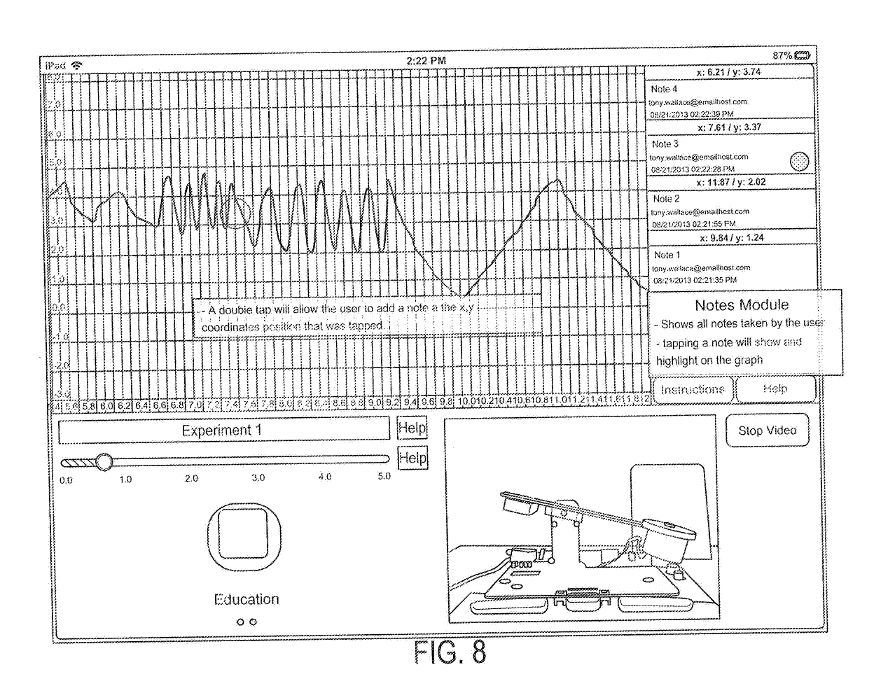

FIG. 8 is a screen shot diagram of a note interface for remote learning according to some embodiments.

The note interface may display one or more experiment notes created via note module 48. The notes may be manipulated via note module using different gestures.

Embodiments described herein may provide improved systems and methods for remote learning in a laboratory environment by establishing dynamic connection streams between hardware clients 30 and mobile clients 28 via a server stack interface 26.

Embodiments described herein may provide improved systems and methods with continuity of interface, interactivity, and user experience making the system easier to use. Content for experiments may be served from one location to multiple geographic locations.

Back-end architecture allows for modular integration of hardware and software. This enables quick and easy integration of new hardware, and back-end architecture elasticity. Back-end architecture elasticity may provide the ability to dynamically expand hardware and software modules to additional server stack instances to accommodate high CPU usage, high user traffic from clients and servers, and so on. This may allow seamless and fast services for all users as well as redundancy for power backup, data backup, and so on.

Embodiments described herein may provide improved systems and methods with all-in-one software/hardware package on the user's end via mobile client 28. The experiment processing may be implemented using remote server 16 or server in other facilities 14. Embodiments described herein may provide improved systems and methods with scalable architecture on the back-end and front-end.

Embodiments described herein may provide improved systems and methods with control over the entire platform which allows ease of modification to achieve new functionality.

Embodiments described herein may provide improved systems and methods using a direct connection between client and server through web-socket allows much more responsive connection, without the overhead of a virtual machine and remote desktop connection.

Embodiments described herein may provide improved systems and methods with a hardware interfacing API which allows for integration of a much wider array of hardware, and much more customization.

Embodiments described herein may provide improved systems and methods designed to be scalable on the back-end with the hardware integration API. Server architecture is designed to be scalable to handle many connections.

Embodiments described herein may also provide a historical record of a personal learning history for a user. Embodiments described herein may a persistent, online storage of user data which may be referred to as an individual's “personal learning history”. The system may store personal learning data is association with a user account, including but not limited to: lecture notes, lab reports (remote and non-remote), bookmarks, useful websites, quizzes, tests, evaluations, assignments, learning plans, planning tools, experiments results, research, projects, and so on. Further, the tool may enable the creation, management, sharing and online progress tracking, of “individual education plans”. The education plans may allow users to set educational goals, strategies, timelines for reaching them, track their progress against them over time, and so on. The material and stored data may be highly searchable and indexed to allow for easy retrieval over time. For example, a user may provide a user name and password in order to access their learning record. System may collect learning data associated with a user, and store the learning data as records associated with a user account. System may index the learning to one or more indices, such as a user identifier, course identifier, subject identifier, tag, and so on.

System and hardware components thereof (as described herein) may be configured to provide an education management interface and one or more educational clients for providing remote learning services as described herein. The education management interface may collect and store learning data to generate the learning records for users. Educational clients may be used to couple mobile clients to hardware resources configured to provide learning services, which may be associated with different facilities 14, instructors, and so on.

Embodiments described herein may also be extended to various entertainment applications. For example, a racing game may involve race cars raced around a real track, where drivers may use system to remotely control the cars. For a multi-player car racing game, players may be disbursed geographically and, through the internet, may be controlling real (e.g. miniature) cars on a real-race track. The drivers may receive real-time telemetry and data from the cars, while also viewing video of the game or race. The whole time, they may have control of the vehicles from their gaming consoles, tables, smart phones, PCs, or other devices.

Accordingly, the concept of remote, real-time control of physical systems can be expanded beyond the education realm into entertainment. As a further example, video games may be three-dimensional simulations of reality, whether driving, fighting or navigating in a simulated world. Some applications of embodiments described herein may blend the entertainment world of simulation with remote, real-time control and feedback from physical systems.

In this manner, embodiments described herein may act as a bridge to allow a centralized location to contain many copies of such physical systems, and enable the collaboration, competition, queuing, of players from anywhere in the world.

To provide a non-limiting, further example of an embodiment, the present system and method may be used for delivering a remote learning experience in relation with teaching control principles which may have hardware for simulating and/or conducting vertical take-off and landing (VTOL). The hardware may be connected through a video feed and may be operable to receive control instructions which may determine various parameters of operation.

In this example, the target audience would be either high school or college students, with whom the platform would be helping understand, through exploration with a hardware plant, that: exact control can be difficult to achieve manually; system constraints can affect how a system is controlled; a computer can often control a system easily than a human; and computer control systems may need a defined set point.

There may be a number of steps in an example interactive lab. The following steps 1-9 are merely for example purposes.

Step 1: Motivation: The system may be configured to provide a video overlay that covers the entire screen, and a voice-over video may be played to motivate the student with details about the use of Vertical Take-Off and Landing craft, as well as introducing the concept of control.

Step 2: Play: The student may be able to operate a control panel having elements such as a slider, to move the Vertical Take-Off and Landing (VTOL) craft. There may be one or more interactive elements, where the student may be able to control various parameters, such as current using a slider bar. The current slider bar may be provided for controlling the amount of current that is driving a motor, and the motor may be controlling how quickly the fan blades spin. At faster fan speeds, more thrust is generated and the VTOL rises. The VTOL may simulate various crafts and/or vehicles, such as a helicopter or vertical take-off jet.

There may be various panels, such as: the graph panel, indicating the pitch of the VTOL along the Y axis, from −15 degrees to +15 degrees; and the video panel, showing the VTOL system responding to the user's input, if the user increases the current, the VTOL may rise, if the user decreases the current, the VTOL may fall.

Step 3: Direct Control: The student may be able to interact with a number of elements at this stage, and various options may be available for the control of the current flowing into the motor of the VTOL, and a help tab may be available for providing guidance to the student, for example, it may indicate that for the VTOL to hover in mid-air, it must not be rising or falling, and that the student should adjust the slider for the current until the pitch of the VTOL is 0 degrees.

Similar to Step 2, there may be a graph panel and a video panel provided.

Step 4: Manual Response: The student may be tasked with manually controlling the VTOL to achieve a hovering position as quickly as possible. The student may be able to interact with various elements, including controlling the current flow to the motors, or choosing to restart the experiment. A help tab may be provided to help guide the student's understanding of how the student can get the VTOL to the desired position as quickly as possible.

Step 5: Measuring Results: The student may be able to view information in relation to the steps taken, such as whether the VTOL went above a pitch of 0, by how much, how long it took to control the VTOL to reach a pitch of 0, etc. The student may have the option to attempt various steps again, and the student may be able to indicate to the system how much overshoot occurred and the time required.

The system may generate guidance through a help tab, which may indicate that, for example, when controlling the VTOL, the fastest way to achieve a pitch of 0 is to increase the current by a large amount, so that the VTOL accelerates upward, and to then decrease the current as it gets closer to a pitch of 0, and that one variation of this behavior is to go above a pitch of 0 and then come back down, which can often be the fastest way to achieve a desired value, but may lead to overshoot. The help may further note that some amount of overshoot is not always a bad thing, depending on the scenario.

Step 6: Optimizing Response: The student may be tasked with optimizing the control of the VTOL in various situations, for example, wherein the VTOL needed to reach a position of 0 as quickly as possible, but it couldn't go any higher than a pitch of 12, because there are power lines above it. Similarly, the student may be able to control the amount of current flowing into the motor, or restart the experiment. Various scenarios may be attempted, for example, where too much overshoot would be undesirable, etc., and the scenario may require an overshoot less than 12 degrees. The graph panel may further indicate the maximum overshoot.

Step 7: Reflection: The student may interact with the system to note various findings and learning points. For example, the system may note that optimizing and controlling a device such as the VTOL manually can be very difficult and that computers are often used to similar control systems, and then ask the student what information would be useful for a computer to know to control the VTOL. The student may also be able to request help.

For example, a help tab could indicate that first, the computer would need to know where the VTOL currently is, and that next, it needs to know where the VTOL is supposed to go.

Step 8: Computer Control: In this step, the system may indicate that the computer has been set up to control the position of the VTOL, but it still needs to know where the student wants it to go (the “Set Point”). The student may be able to use a slider to define the Set Point, and to observe what happens.

The student may be able to control the desired pitch of the VTOL as well, and observe what happens when the student instructs the control system related to the VTOL to go to a pitch of 0. The student may be instructed to observe the differences from when the student was controlling the VTOL.

Step 9: Quiz: The student may be requested to answer a number of questions in relation to the experiment.

The system may be configured to develop a learning history during the course of the interaction, wherein the system collects learning data from the mobile clients used by the students, and may be monitoring the progress of in relation to an education plan. Collected learning data may be indexed and/or have various met stags or data associated with it, such as information indicating a user identifier course identifier, subject identifier, tag, keywords, etc.

This collected learning data may be used for a variety of purposes, such as searching, reporting, analytics, display, etc.

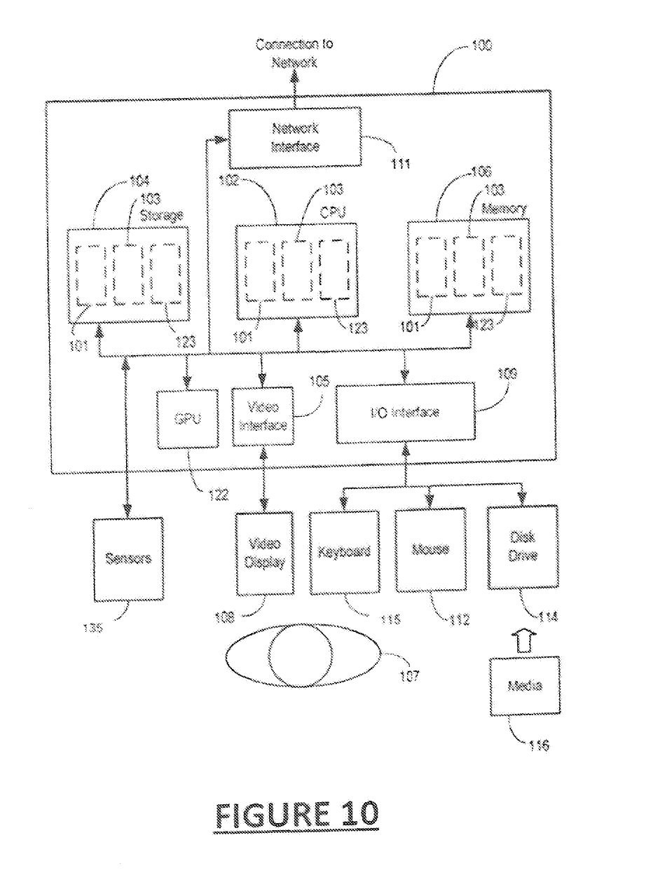

The present system and method may be practiced in various embodiments. A suitably configured computer device, and associated communications networks, devices, software and firmware may provide a platform for enabling one or more embodiments as described above. By way of example, FIG. 10 shows a computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 115, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 135 may be used to receive input from various sources.

The present system and method may be practiced on various computer devices, including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

The functionality described may be implemented to any mobile platform, including the iOS™ platform, ANDROID™, WINDOWS™ or BLACKBERRY™. With respect to computer-implemented embodiments, the description provided may describe how one would modify a computer to implement the system or steps of a method. The specific problem being solved may be in the context of a computer-related problem, and the system may not be meant to be performed solely through manual means or as a series of manual steps.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

1. A system for remote laboratory learning comprising:
(a) one or more mobile clients residing on client computing devices
(b) one or more hardware clients coupled to equipment and hardware for a laboratory experiment or research configured to conduct a laboratory experiment;
(c) processor configuring a server stack interface to establish a communication stream between the one or more mobile clients and the one or more hardware clients to remotely communicate commands and messages to conduct the laboratory experiment.

2. The system of claim 1, wherein the server stack interface comprises a websocket stack to handle the communication stream between the one or more mobile clients and the one or more hardware clients.

3. The system of claim 1, wherein the server stack interface comprises an application programming interface stack to authenticate the communication stream using a session identifier unique to the communication stream.

4. The system of claim 1, wherein the server stack interface comprises an analytics module to provide data, performance and error tracking reports.

5. The system of claim 1, wherein the hardware clients receive the commands to control the equipment and hardware coupled thereto to conduct the experiment and vary parameters of the experiment.

6. The system of claim 1, wherein the server stack interface comprises customizable libraries for the one or more hardware clients to provide custom control configurations to the one or more mobile clients.

7. The system of claim 1, wherein the mobile client comprises a login module is operable to interact with server stack interface to the client computing device.

8. The system of claim 1, wherein the mobile client comprises a graph module is operable to provide feedback from analog/digital signals routed by the server interface from the hardware clients, and manipulate and generate graphs using data from experiments.

9. The system of claim 1, wherein the mobile client comprises a experiment control module to provide step by step information about the experiment.

10. The system of claim 1, wherein the mobile client comprises a note module operable to enable the create and manipulate notes on the experiment.

11. The system of claim 1, wherein the mobile client comprises a live video module to display live video feedback from the hardware.

12. The system of claim 1, wherein the mobile client comprises a help module is operable to provide overall help for the experiment through contents such as text, images, videos, and external links.

13. The system of claim 1, wherein the mobile client comprises a collaboration module operable to enable experiment collaboration.

14. The system of claim 1, wherein the mobile client comprises a report module operable to dynamically generate reports using the experiment data collected via the equipment and hardware, such as graph images, graph data, experiment summary, experiment steps, user notes.

15. The system of claim 1, wherein the mobile client comprises a notification and analytics module which enables the client to receive notifications and collect analytic information about the experiment and client usage.

16. The system of claim 1, further comprising one or more web client to enable creation of content for the experiments.

17. The system of claim 1, further comprising one or more web client to retrieve and present data to administrators to configure the system.

18. The system of claim 1, further comprising one or more web client to schedule experiments.

19. The system of claim 1, further comprising one or more web client to enable registration and maintenance.

20. A method for remote laboratory learning comprising:
providing one or more mobile clients on a corresponding one or more client computing devices;
providing one or more hardware clients coupled to equipment and hardware for a laboratory experiment;
using one or more processors to configure a server stack interface; and
establishing, using the server stack interface, a communication stream between the one or more mobile clients and the one or more hardware clients to remotely communicate commands and messages to conduct the laboratory experiment.

21. The method of claim 20 wherein establishing the communication stream comprises:
receiving a request for a session identifier from a client, wherein the request comprises authentication data;
authenticating the client using the authentication data;
after proper authentication, returning the session identifier to the requesting client;
receiving a request for a connection stream from the client;
sending a request to the client for a valid session identifier;
receiving the session identifier form the client;
validating the session identifier; and
after proper validation, opening and completing the communication stream.

22. A system for remote laboratory learning comprising:
(a) one or more mobile clients residing on client computing devices, wherein each mobile client is associated with at least one user;
(b) an education management interface configuring a processor to establish a communication stream between the one or more mobile clients and one or more educational clients to remotely communicate commands and messages to for remote learning, wherein the server interface is configured to provide a learning history for each of the users by:
(i) collecting learning data for the users associated with the mobile clients, wherein the learning data may comprise lecture notes, lab reports (remote and non-remote), bookmarks, useful websites, quizzes, tests, evaluations, assignments, learning plans, planning tools, experiments results, research, projects, and so on;
(ii) generate an education plan;
(iii) monitor the progress of the education plan using the collected learning data;
(iv) indexing the collected learning data for storage with one or more indices to associate the learning data with a particular user, wherein the index may comprise a user identifier, course identifier, subject identifier tag; and
(v) store the learning data for subsequent search and retrieval.
